(19) United States
(12) Patent Application Publication
(10) Pub. No.: US 2025/0273416 A1
(43) Pub. Date: Aug. 28, 2025

(54) SOLID STATE HYBRID CIRCUIT BREAKER TOPOLOGY USING DUAL ULTRAFAST OPENING CONTACTS

(71) Applicant: EATON INTELLIGENT POWER LIMITED, DUBLIN 4 (IE)

(72) Inventor: Andrew W. Lichauer, McMurray, PA (US)

(73) Assignee: EATON INTELLIGENT POWER LIMITED, DUBLIN 4 (IE)

(21) Appl. No.: 18/585,390

(22) Filed: Feb. 23, 2024

(51) Int. Cl. H01H 33/28; H01H 71/12; H02H 3/05; H02H 3/08

(52) U.S. Cl. CPC H01H 33/28; H02H 3/05; H02H 3/08; H01H 71/123

(57) ABSTRACT

A hybrid switch assembly for switching AC current in a circuit interrupter includes a power electronics (PE) branch connected in parallel with a mechanical branch. The PE branch includes two series connected modules, PE+ and PE−. The mechanical branch includes two series connected pairs of separable contacts, MEC+ and MEC−. The PE+ module and MEC+ contacts interrupt current during a positive voltage half-cycle, and the PE− module and MEC− interrupt current during a negative voltage half-cycle. Including two sets of separable contacts requires only the PE module oriented in the direction of the current at the time of interruption to be powered on and enables the other PE module to remain powered off, so that excess resistive heat losses and impedance-based losses that would otherwise be incurred by powering on both PE modules are avoided.

### FIELD OF THE INVENTION

The disclosed concept relates generally to hybrid circuit interrupters, and in particular, to systems and methods for reducing power losses across the power electronics branches of hybrid circuit interrupters during current interruption operations.

### BACKGROUND OF THE INVENTION

Circuit interrupters, such as for example and without limitation, circuit breakers, are typically used to protect electrical components and systems from damage caused by an overcurrent condition, such as and not limited to: overload conditions, short circuits, arc faults, and ground faults. Circuit interrupters are typically rated based on their electro-mechanical ability to: carry current during steady state operation, withstand overcurrent conditions for a specified duration, successfully break/interrupt current, and sustain several of the above-listed events to a manufacturer-specified limit.

Circuit interrupters typically include mechanically separable contacts, an operating mechanism configured to operate the separable contacts as a switch mechanism, a trip mechanism configured to control the operating mechanism based on control logic, and a stored energy dissipation mechanism designed to release stored system energy. The separable contacts are configured to be actuated between a closed state and an open state by the operating mechanism. In the closed state, the separable contacts are in physical and electrical contact with one another, enabling current to flow from the line side to the load side of the circuit interrupter. In the open state, the separable contacts are physically separated and electrically isolated one another, so as to prevent the flow of current between the line side and the load side of the circuit interrupter. In vacuum circuit interrupters, the separable contacts are enclosed in a vacuum housing, while in air-gap circuit interrupters, the separable contacts are surrounded by air.

When a typical air-gap circuit interrupter opens its separable contacts during a fault condition or other non-zero energy state, the stored energy in the system gets released in the form of an electrical arc generated across the separable contacts. This arc acts as a short circuit across the contacts, allowing the fault current to continue to rise even after the separable contacts are opened. In AC systems, arcing will last until the remaining system energy is depleted, which is typically at the next zero crossing of the current. Only when the arc is completely extinguished is the circuit interrupter considered fully open.

Several techniques and methods have been developed to extinguish arcing as quickly as possible. Reducing the arc duration shortens the overall fault duration and let-through energy, protecting both connected electronic devices and people near the fault and/or arc. Limiting the arc duration also increases the overall capability of the circuit interrupter by reducing wear on the mechanical contacts and operating mechanism.

Recent advances in wide-band gap semiconductor technology have made it possible to produce power electronic devices with low conduction losses suitable for power transmission/distribution. A pure solid-state circuit interrupter would provide the fastest possible current interruption time since it does not require waiting for the next zero crossing in current and would completely remove the arcing internal to the device, but it would also result in higher conduction losses compared to a device with mechanical contacts. In addition, thermal management would be necessary to ensure the reliability of a pure solid-state circuit interrupter, as power electronics are sensitive to heat. Circuit interrupters are already subject to challenging thermal requirements and are naturally desired to be passively cooled to ensure reliability.

To offset the thermal management problem introduced by pure solid state circuit interrupters, a hybrid circuit interrupter can be used. During steady state operation, the hybrid device uses its mechanical contacts to achieve the lowest possible conduction losses. When a fault or overcurrent occurs, the hybrid device activates a parallel power electronics branch as part of its energy dissipation mechanism. If a fault or other interruption is triggered, the mechanical contacts are opened. After a small arc voltage is developed, the power electronics are switched on in parallel across the mechanical contacts. This small arc voltage drives the current to commutate from the mechanical contacts to the power electronics branch, and the power electronics branch can then be switched back off to absorb and dissipate the remaining system energy without needing to wait for a zero crossing.

Several factors must accounted for in order for a hybrid circuit interrupter to operate at maximum effectiveness. First, the mechanical branch must open fast enough to develop commutation voltage. Second, the power electronics branch must be able to interrupt bi-directional current. In order to achieve interruption of bi-directional current, known hybrid circuit interrupters use two unidirectional power electronics devices oriented in opposing orientations. Having two unidirectional power electronics devices leads to there being twice as much on-resistance in the hybrid circuit interrupter, as compared to the on-resistance of a single unidirectional device. Among other consequences, the increased on-resistance introduced by having two unidirectional power electronics devices affects commutation time, increases loop impedance, increases conduction losses, and reduces on duration of the power electronics branch.

There is thus room for improvement in hybrid circuit interrupters.

### SUMMARY OF THE INVENTION:

These needs, and others, are met by a hybrid switch assembly for a circuit interrupter that is structured to interrupt AC current without incurring heat and power losses that would otherwise be generated from a non-switching power electronics module. The disclosed hybrid switch assembly includes a power electronics (PE) branch connected in parallel with a mechanical branch. The PE branch includes two series connected modules, PE+ and PE−. The mechanical branch includes two series connected pairs of separable contacts, MEC+ and MEC−. The PE+ module and MEC+ contacts interrupt current during a positive voltage half-cycle, and the PE− module and MEC− interrupt current during a negative voltage half-cycle. Including two sets of separable contacts requires only the PE module oriented in the direction of the current at the time of interruption to be powered on and enables the other PE module to remain powered off, so that excess resistive heat losses and impedance-based losses that would otherwise be incurred by powering on both PE modules are avoided.

In accordance with one aspect of the disclosed concept, a hybrid switch assembly for use in a circuit interrupter comprises: a line side node configured to be connected to a power source; a load side node configured to be connected to a load; a mechanical branch connected between the line side node and the load side node; a power electronics (PE) branch connected between the line side node and the load side node in parallel with the mechanical branch; and a control power circuit. The mechanical branch includes a first pair of separable contacts and a second pair of separable contacts positioned in series with the first pair of separable contacts, with the first pair of separable contacts being designated as MEC+ separable contacts and the second pair of separable contacts being designated as MEC− separable contacts. The PE branch includes a first PE module configured to conduct current in a first direction and a second PE module configured to conduct current in a second direction oriented opposite the first direction, with the first PE module being designated as a PE+ module and the second PE module being designated as a PE− module. The control power circuit is configured to selectively actuate each of the PE+ module and the PE− module between a conducting state and a nonconducting state. The MEC+ separable contacts form a first hybrid interrupting arrangement with the PE+ module and are connected in parallel with the PE− module, and the MEC− separable contacts form a second hybrid interrupting arrangement with the PE− module and are connected in parallel with the PE+ module.

In accordance with another aspect of the disclosed concept, a hybrid circuit interrupter structured to be connected between a power source and a load comprises: a current sensor structured to sense current flowing through the hybrid circuit interrupter; a voltage sensor structured to sense voltage in the hybrid circuit interrupter; a controller configured to receive data from the current sensor and the voltage sensor; an operating mechanism configured to be actuated by the controller; and a hybrid switch assembly. The hybrid switch assembly comprises: a hybrid switch assembly for use in a circuit interrupter comprises: a line side node configured to be connected to the power source; a load side node configured to be connected to the load; a mechanical branch connected between the line side node and the load side node, a power electronics (PE) branch connected between the line side node and the load side node in parallel with the mechanical branch, and a control power circuit. The mechanical branch includes a first pair of separable contacts and a second pair of separable contacts positioned in series with the first pair of separable contacts, with the first pair of separable contacts being designated as MEC+ separable contacts and the second pair of separable contacts being designated as MEC− separable contacts. The PE branch includes a first PE module configured to conduct current in a first direction and a second PE module configured to conduct current in a second direction oriented opposite the first direction, with the first PE module being designated as a PE+ module and the second PE module being designated as a PE− module. The control power circuit is in communication with the controller and configured to selectively actuate each of the PE+ module and the PE− module between a conducting state and a nonconducting state. The MEC+ separable contacts form a first hybrid interrupting arrangement with the PE+ module and are connected in parallel with the PE− module, and the MEC− separable contacts form a second hybrid interrupting arrangement with the PE− module and are connected in parallel with the PE+ module.

In accordance with a further aspect of the disclosed concept, a method of interrupting current flowing between a power source and a load comprises: comprises: providing a hybrid circuit interrupter electrically connected between the power source and the load, the hybrid circuit interrupter including a hybrid switch assembly, wherein the hybrid switch assembly includes a mechanical branch and a power electronics (PE) branch connected in parallel with the mechanical branch, the mechanical branch including a first pair of separable contacts and a second pair of separable contacts positioned in series; maintaining the first pair and the second pair of separable contacts in a closed state and keeping the PE branch powered off when the current is within a normal operating range of the circuit interrupter; and when the current reaches a fault level threshold: determining whether the current is in a positive voltage half-cycle or in a negative voltage half-cycle, and initiating a positive voltage interruption sequence when the current is in the positive voltage half-cycle and initiating a negative voltage interruption sequence when the current is in the negative voltage half-cycle. The first pair of separable contacts are designated as MEC+ separable contacts and the second pair of separable contacts are designated as MEC− separable contacts. The PE branch includes a first PE module configured to conduct current in a first direction and a second portion configured to conduct current in a second direction. The MEC+ separable contacts form a first hybrid interrupting arrangement with the PE+ module and are connected in parallel with the PE− module. The MEC− separable contacts form a second hybrid interrupting arrangement with the PE− module and are connected in parallel with the PE+ module.

### BRIEF DESCRIPTION OF THE DRAWINGS:

A full understanding of the invention can be gained from the following description of the preferred embodiments when read in conjunction with the accompanying drawings in which:

FIG. 1 is a schematic diagram of a prior art hybrid circuit interrupter including a hybrid switch assembly;

FIG. 2 is a schematic diagram of the prior art hybrid switch assembly used in the circuit interrupter shown in FIG. 1;

FIG. 3 is a schematic diagram of an improved hybrid circuit interrupter that includes an improved hybrid switch assembly, in accordance with an exemplary embodiment of the disclosed concept;

FIG. 4 is a schematic diagram of one non-limiting implementation of the improved hybrid switch assembly shown in FIG. 3, with n-channel MOSFETs used as the power electronics modules, in accordance with an exemplary embodiment of the disclosed concept;

FIG. 5 is a flow chart of a method for interrupting current through a hybrid circuit interrupter in accordance with an example embodiment of the disclosed concept;

FIG. 6 is a flow chart of a positive voltage interruption sequence that can be initiated at the end of the method shown in FIG. 5, in accordance with an exemplary embodiment of the disclosed concept; and

FIG. 7 is a flow chart of a negative voltage interruption sequence that can be initiated at the end of the method shown in FIG. 5, in accordance with an exemplary embodiment of the disclosed concept.

### DETAILED DESCRIPTION OF THE INVENTION:

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As employed herein, when ordinal terms such as “first” and “second” are used to modify a noun, such use is simply intended to distinguish one item from another, and is not intended to require a sequential order unless specifically stated.

As employed herein, the term “number” shall mean one or an integer greater than one (i.e., a plurality).

As employed herein, the term “controller” shall mean a programmable analog and/or digital device that can store, retrieve, and process data; a microprocessor; a microcontroller; a microcomputer; a central processing unit; or any suitable processing device or apparatus.

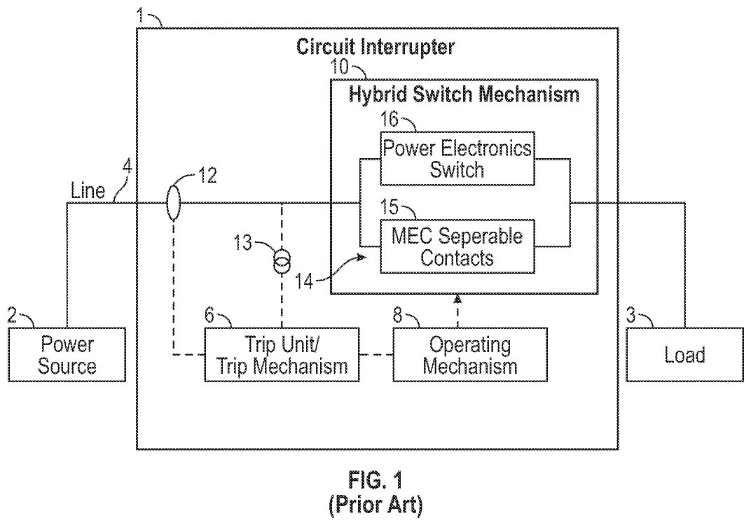

FIG. 1 is a schematic diagram of a prior art hybrid circuit interrupter 1. The circuit interrupter 1 (e.g., without limitation, a circuit breaker) is structured to be electrically connected between an AC power source 2 and a load 3 via a line conductor 4. The circuit interrupter 1 is structured to trip open (i.e. switch open) to interrupt current flowing between the power source 2 and load 3 in the event of a fault condition (e.g., without limitation, an overcurrent condition) to protect the load 3, circuitry associated with the load 3, as well as the power source 2. The circuit interrupter I includes a trip unit 6, an operating mechanism 8, and a hybrid switch mechanism 10. The trip unit 6 is structured to monitor power flowing through the circuit interrupter 1 via a current sensor 12, a voltage sensor 13, and/or other sensors and to detect fault conditions based on the power flowing through the circuit interrupter 1. The hybrid switch mechanism 10 includes a mechanical branch 14 comprising mechanical separable contacts 15 and a power electronics branch 16 comprising a power electronics switch. The power electronics branch 16 is also referred to hereinafter as the power electronics switch 16.

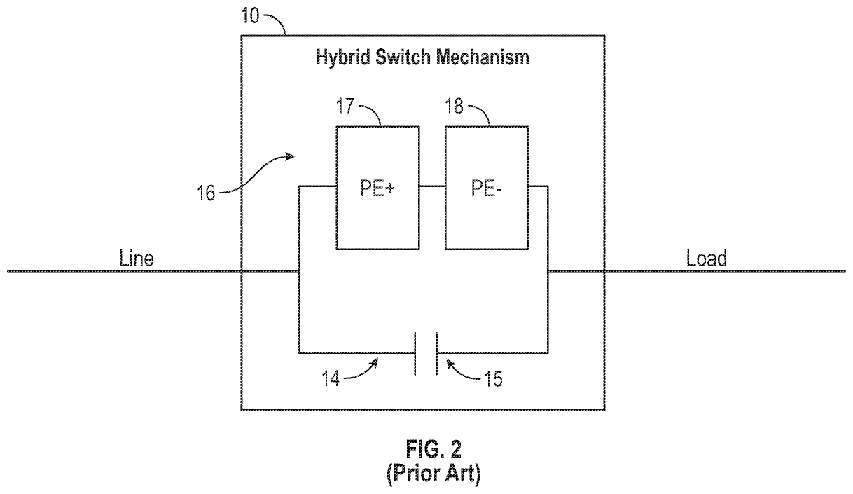

Referring now to FIG. 2 in conjunction with FIG. 1, FIG. 2 is a schematic depiction of the prior art hybrid switch mechanism 10 of FIG. 1, shown in more detail. The hybrid switch mechanism 10 includes the mechanical branch 14 comprising one pair of mechanical separable contacts 15 and the power electronics branch comprising two unidirectional power electronics modules 17, 18 connected in series. The power electronics module 17 is oriented so as to be able to interrupt current during a positive half cycle of the AC power signal supplied by the power source 2, and the power electronics module 18 is oriented so as to be able to interrupt current during a negative half cycle of the AC power signal supplied by the power source 2. The power electronics module 17 is referred to hereinafter as the PE+module 17 for brevity, and the power electronics module 18 is referred to hereinafter as the PE− module 18 for brevity. However, it is noted that the PE+ and PE− modules 17, 18 may also be referred to generally and collectively or generally and individually as the PE module(s).

The PE modules 17, 18 can comprise, for example, a number of semiconductor devices, such as FETs and/or BJTs. In one non-limiting example, the PE+ module 17 can comprise an n-channel MOSFET oriented in a first direction, and the PE− module 18 can comprise another n-channel MOSFET oriented in a second direction oriented opposite the first direction. Typically, each PE module 17, 18 is provided with its own driver (not shown in the figure) that is configured to selectively provide the voltage and/or current required to actuate the PE module 17, 18 between its active (i.e. conducting) state and its inactive (i.e. nonconducting) state.

Still referring to FIG. 2 in conjunction with FIG. 1, the circuit interrupter 1 is configured to maintain the separable contacts 15 in a closed state and keep the power electronics switch 16 powered off when current levels are within the predetermined normal operating range of the circuit interrupter I so that the current can flow from the power source 2 through the line conductor 4 and the separable contacts 15 to the load 3. When the trip unit 6 detects a fault condition, the trip unit 6 actuates the operating mechanism 8 to physically separate the separable contacts 15 to an open state. After a small arc voltage is developed as a result of the separable contacts 15 separating, the power electronics switch 16 is switched on in parallel across the separable contacts 15. This small arc voltage drives the current to commutate into the power electronics switch 16.

Once the current is commutated to the power electronics switch 16, the mechanical contacts 25 can open with a reduced risk of arcing. The power electronics switch 16 is configured to remain powered on only for a very short time such that, shortly after the current is commutated, the power electronics switch 16 is powered off in order to fully break the line connection between the power source 2 and the load 3. It is noted that the power electronics switch 16 can be switched off to absorb and dissipate the remaining system energy without waiting for a zero crossing. Although not shown in FIG. 1, hybrid circuit interrupters are known to include snubber circuits, and any energy remaining in the system due to inductance of the system can be absorbed by the power electronics switch 16 and the snubber circuit. Turning on both PE modules 17, 18 for every interruption ensures that current flow can be interrupted in either direction during any given interruption and simplifies the control logic for the hybrid switch mechanism 10, but it should be noted that only one of the PE modules 17, 18 actually functions as a switch during a given interruption operation. That is, only the PE+ module 17 functions as a switch during the positive half-cycle of power, and only the PE− module 18 functions as a switch during the negative half-cycle of power.

It will be appreciated that ON resistance is a characteristic inherent to typical semiconductor devices. As such, turning on both PE modules 17, 18 for every interruption operation leads to excess resistive power losses, as the current is subjected to the ON resistance of both the switching PE module 17 or 18 and the non-switching PE module 18 or 17 during every interruption operation, even though only one of the two PE modules 17 or 18 actually switches off the current during a given interruption operation. For example and without limitation, when the PE modules 17, 18 are MOSFETs, the ON resistance of each PE module 17, 18 is due to the conducting effect of each PE module's body diode.

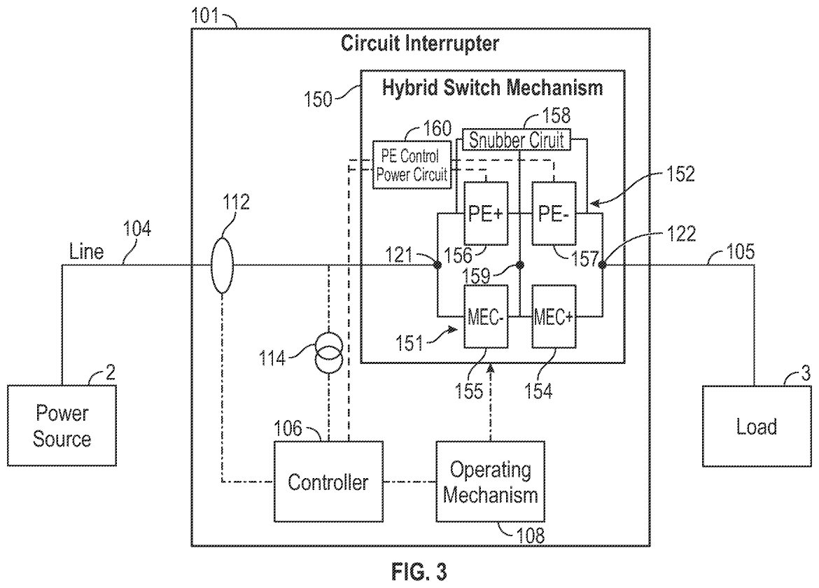

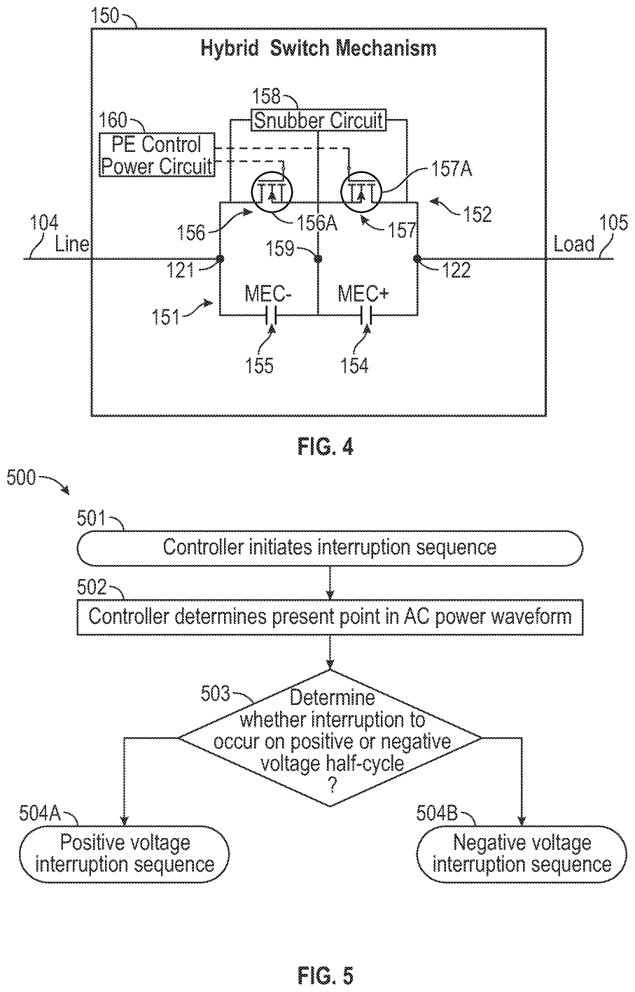

Referring now to FIG. 3, a schematic depiction of an improved hybrid circuit interrupter 101 that includes an improved hybrid switch mechanism 150 is shown, in accordance with an exemplary embodiment of the disclosed concept. FIG. 4 is a schematic depiction of one non-limiting implementation of the improved hybrid switch mechanism 150 of FIG. 3, wherein each power electronics module comprises an n-channel MOSFET, in accordance with an exemplary embodiment of the disclosed concept. The hybrid circuit interrupter 101 operates using some of the same basic principles as the prior art hybrid circuit interrupter 1 shown in FIG. 1, but in the improved hybrid circuit interrupter 101, the hybrid switch mechanism 150 is used in place of the prior art hybrid switch mechanism 10 that was used in the hybrid circuit interrupter 1. The hybrid circuit interrupter 101 is structured to connect a load 3 to a power source 2 via a line conductor 104 and a load conductor 105. The hybrid circuit interrupter 101 includes a controller 106, an operating mechanism 108, a current sensor 112, and a voltage sensor 114.

The controller 106 is structured to monitor current flowing through the circuit interrupter 101 via the current sensor 112 and to monitor the voltage of the line conductor 104 based on the voltage sensor 114, and to detect fault conditions based on the information provided by the current sensor 112, voltage sensor 114, and/or other sensors. The AC power signal supplied by the power source 2 is said to be in the positive half-cycle when the voltage at the line side (e.g. at a node 121 in FIG. 3) of the circuit interrupter 101 is greater than the voltage at the load side (e.g. at a node 122 in FIG. 3) of the circuit interrupter 101. Conversely, the AC power signal supplied by the power source 2 is said to be in the negative half-cycle when the voltage at the load side (e.g. at the node 122) of the circuit interrupter 101 is greater than the voltage at the line side (e.g. at the node 121) of the circuit interrupter 101. The controller 106 monitors whether the current through the line conductor 104 is in the positive or negative half-cycle based on the data sensed by the current sensor 112, voltage sensor 114, and/or other sensors.

Similarly to the prior art hybrid switch mechanism 10, the disclosed improved hybrid switch mechanism 150 includes a mechanical branch 151 and a power electronics branch 152 (the power electronics branch 152 also being referred to hereinafter as the “PE branch 152” and the “PE switch 152”). However, the mechanical branch 151 comprises two pairs 154 and 155 of mechanical separable contacts, rather than just one pair as the prior art mechanical branch 14 does. The PE branch 152 comprises two unidirectional PE (power electronics) modules 156 and 157 connected in series in opposing orientations in order to enable interruption of AC current in either direction. In addition, a snubber circuit 158 is connected in parallel with each of the PE modules 156, 157. Both the switching PE module 156 or 157 and the snubber circuit 158 absorb any energy remaining in the system during an interruption operation due to inductance of the system, which eliminates the need to wait for a zero crossing in order to complete interruption.

Both pairs 154, 155 of mechanical separable contacts and both of the unidirectional PE modules 156, 157 are connected to a common node 159. The node 121 is connected to both the power source 2 and the hybrid switch mechanism 150 and is referred to hereinafter as the line side node 121. The node 122 is connected to both the hybrid switch mechanism 150 and the load 3 and is referred to hereinafter as the load side node 122.

The hybrid switch mechanism 150 is structured so as to form two hybrid interrupting arrangements between the line side node 121 and the load side node 122 (for clarity of illustration, the two hybrid interrupting arrangements are not numbered with additional reference numbers in the figures). The first hybrid interrupting arrangement comprises the PE module 156 and the separable contacts 154 and is referred to as the positive interrupting arrangement for reasons that will become apparent hereafter. The second hybrid interrupting arrangement comprises the PE module 157 and the separable contacts 155 and is referred to as the negative interrupting arrangement for reasons that will become apparent hereafter.

The PE module 156 is oriented so as to be able to conduct and consequently interrupt current during the positive half-cycle of the AC power signal and is thus referred to hereinafter as the PE+ module 156 for brevity and clarity. The PE module 157 is oriented so as to be able to conduct and consequently interrupt current during a negative half cycle of the AC power signal and is thus referred to hereinafter as the PE− module 157 for brevity and clarity. The PE+ and PE− modules 156, 157 may also be referred to generally and collectively or generally and individually as the “PE module(s)”. For ease of reference, the separable contacts 154 are labeled in FIG. 3 as MEC+ and are sometimes referred to hereinafter as the MEC+separable contacts 154 in order to denote their cooperation with the PE+ module 156 to interrupt power during the positive half-cycle of power as part of the positive interrupting arrangement. In addition, for ease of reference, the separable contacts 155 are labeled in FIG. 3 as MEC− and are sometimes referred to hereinafter as the MEC− separable contacts 155 in order to denote their cooperation with the PE− module 157 to interrupt power during the negative half-cycle of power as part of the negative interrupting arrangement.

Structurally, the PE+ module 156 and the MEC− separable contacts 155 are connected in parallel between the line side node 121 and the common node 159, and the PE− module 157 and the MEC+ separable contacts 154 are connected in parallel between the common node 159 and the load side node 122. When current through the hybrid circuit interrupter 101 is within the rated normal operating range of the hybrid circuit interrupter 101, the hybrid circuit interrupter 101 is configured to maintain both pairs 154 and 155 of separable contacts in the closed state and to keep the PE switch 152 powered off (i.e. such that both PE modules 156, 157 are powered off), so that current can only flow through the mechanical branch 151, i.e. from the power source 2 through the line conductor 4 and though both pairs 154, 155 of separable contacts to the load 3. The hybrid switch mechanism 150 includes a PE (power electronics) control power circuit 160 that is in communication with the controller 106 and that is configured to selectively provide the voltage and/or current needed to power on and power off each PE module 156, 157. It will be appreciated that powering on each PE module 156, 157 actuates it to its active (i.e. conducting) state, and powering off each PE module 156, 157 actuates it to its inactive (i.e. nonconducting) state.

Each of the PE modules 156, 157 comprises a number of semiconductor devices, such as FETs and/or BJTs, for example and without limitation. In one non-limiting example, as shown in FIG. 4, the PE+ module 156 can comprise an n-channel MOSFET 156A oriented in a first direction with its drain terminal connected to the line side node 121, and the PE− module 157 can comprise another n-channel MOSFET 157A oriented in a second direction opposite the first direction with its drain terminal connected to the load side node 122, with both MOSFETs 156A, 157A being connected in a common source configuration such that the source terminals of both MOSFETs 156A, 157A are connected to the common node 159 (thus enabling AC power to be interrupted in either direction) and such that the gate terminals of both MOSFETs 156A, 157A receive input from the PE control power circuit 160 in order to be actuated between the conducting and non-conducting states.

The specific steps executed during a current interruption operation of the hybrid circuit interrupter 101 will now be discussed in conjunction with FIGS. 5-7. FIG. 5 is a flowchart of a method 500 of interrupting current in a hybrid circuit interrupter in accordance with an example embodiment of the disclosed concept. The method of FIG. 5 may be employed, for example, with the hybrid circuit interrupter 101 shown in FIG. 3 and is described in conjunction with the hybrid circuit interrupter 101 shown in FIG. 3. However, it will be appreciated that the method may be employed in other devices as well without departing from the scope of the disclosed concept. The method begins at 501, where the controller 106 determines that a current interruption sequence should be initiated. Determining a need for initiation of current interruption can be based, for example and without limitation, on the controller 106 detecting a fault condition based on data detected by the current sensor 112 and/or voltage sensor 114. At 502, the controller 106 determines whether the AC power signal is in the positive or negative voltage half-cycle. At 503, the controller 106 determines whether current interruption should occur during the positive voltage half-cycle or during the negative voltage half-cycle. Specifically, if the AC power signal is in the positive voltage half-cycle at 502, then the controller 106 determines at 503 that current interruption will occur during the positive voltage half-cycle, and if the AC power signal is in the negative voltage half-cycle at 502, then the controller 106 determines at 503 that current interruption will occur during the negative voltage half-cycle.

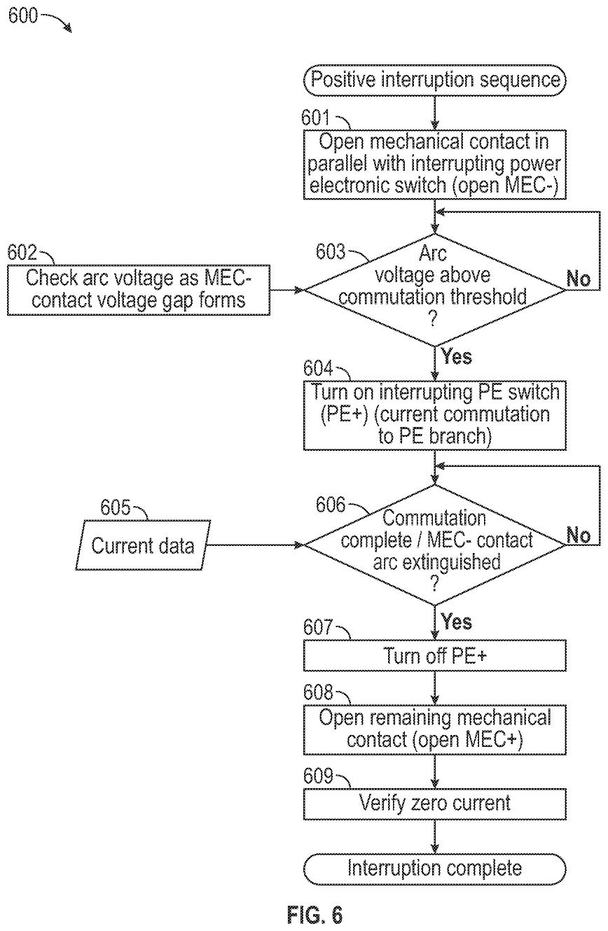

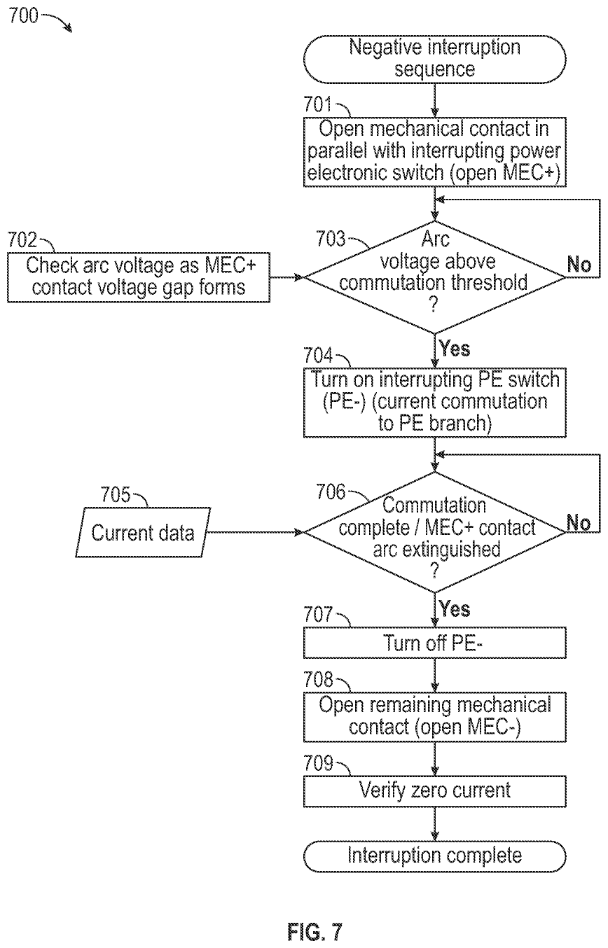

If it is determined at step 503 that current interruption will occur during the positive voltage half-cycle, then the method proceeds to step 504A where the controller 106 initiates a positive voltage interruption sequence, and if it is determined at step 503 that current interruption will occur during the negative voltage half-cycle, then the method proceeds to step 504B where the controller 106 initiates a negative voltage interruption sequence. The positive voltage interruption sequence referenced at step 504A is detailed further in conjunction with FIG. 6, and the negative voltage interruption sequence referenced at step 504B is detailed further in conjunction with FIG. 7.

Reference is now made to FIG. 6 and FIG. 7. FIG. 6 is a flow chart of the positive voltage interruption sequence 600 referenced at step 504A of method 500 shown in FIG. 5, and FIG. 7 is a flow chart of the negative voltage interruption sequence 700 referenced at step 504B of method 500 shown in FIG. 5. The steps of the positive voltage interruption sequence 600 and the steps of the negative voltage interruption sequence 700 closely mirror one another, as the only difference between the two interruption sequences 600 and 700 is that one is executed during the positive voltage half-cycle and one is executed during the negative voltage half-cycle. Thus, the two sequences 600 and 700 will be explained simultaneously for the sake of brevity, and differentiated as needed.

At steps 601 and 701, the controller 106 actuates the operating mechanism 108 to open the mechanical separable contacts pair 155 or 154 that is connected in parallel with the interrupting PE module 156 or 157. It should be noted that the other mechanical separable contacts pair 157 or 156 remains closed at steps 601 and 701. For step 601, the interrupting PE module is the PE+ module 156, so the MEC− separable contacts 155 get opened and the MEC+separable contacts 154 are kept closed. For step 701, the interrupting PE module is the PE− module 157, so the MEC+ separable contacts 154 get opened and the MEC− separable contacts 155 are kept closed.

The opening of the MEC− separable contacts 155 at step 601 causes arc voltage to develop across the MEC− contacts 155, and the opening of the MEC+ separable contacts 154 at step 701 causes arc voltage to develop across the MEC+ contacts 154. That is, as the separable contacts 155 or 154 physically separate, an arc voltage is generated across the gap between the separable contacts 155 or 154. Thus, after step 601 or step 701 is performed, a corresponding step 602 or 702 starts, with step 602 being waiting for the formation of a threshold voltage gap across the MEC− contacts 155 and step 702 being waiting for the formation of a threshold voltage gap across the MEC+ contacts 154 (the “threshold” with respect to the voltage gap being explained at steps 603 and 703).

At steps 603 and 703, the controller 106 determines whether the arc voltage developing across the gap at step 602 or 702 has exceeded a commutation threshold. The commutation threshold voltage is based on the ON resistance of each individual PE module 156, 157. That is, each PE module 156, 157 has an ON resistance, and the current will not commutate from the mechanical branch 151 to the PE branch 152 unless the ON resistance of the PE branch 152 is less than the resistance of the mechanical branch 151. Stated alternatively, the resistance of the mechanical branch 151 must exceed the ON resistance of the PE branch 152 in order for current to commutate from the mechanical branch 151 to the PE branch 152. It will be appreciated that the arc voltage increases as the distance between the MEC− contacts 155 or the distance between the MEC+ contacts 154 increases during opening of the contacts 155 or 154. Because resistance is proportional to voltage, it will be appreciated that there is a level of contact gap voltage that corresponds to the resistance of the mechanical branch 151 exceeding the ON resistance of the PE branch 152, and this voltage level is the threshold commutation voltage referred to at steps 603 and 703.

When the controller 106 determines that the contact gap voltage has exceeded the threshold commutation voltage, then the controller 106 proceeds to step 604 or 704. Prior to the contact gap voltage exceeding the threshold commutation voltage, the sequence 600 or 700 continuously executes step 603 or 703 until the contact gap voltage exceeds the threshold commutation voltage. At step 604, the controller 106 sends a command to the PE control power circuit 160 to power on the PE+ module 156, and at step 704, the controller 106 sends a command to the PE control power circuit 160 to power on the PE− module 157. As a result of performing step 604 or step 704, the current commutates to the PE branch 152 from the mechanical branch 151. More specifically, during the sequence 600, current flows from node 121 to the PE+ module 156 rather than flowing toward the MEC− contacts 155, and during sequence 700, current flows from the node 122 to the PE− module 157 rather than flowing toward the MEC+ contacts 154.

Once current has been commutated at step 604 or step 704, the controller 106 continuously checks data from the current sensor 112 at step 605 or step 705, in order to determine at step 606 or 706 if the arc across the opened mechanical contacts 155 or 154 (i.e. the arc across the MEC− contacts 155 at step 606 and the arc across the MEC+ contacts 154 at step 706) has extinguished yet. The sequence remains at step 606 or 706 for the duration of the arc event. Once the controller 106 determines that the arc across the opened mechanical contacts 155 or 154 has extinguished, the sequence progresses to step 607 or 707, where the controller 106 instructs the PE control power circuit 160 to power off the interrupting PE module (the PE+module 156 for sequence 600, the PE− module 157 for sequence 700). The PE branch 152 and snubber circuit 158 absorb the remaining stored system energy once the interrupting PE module is powered off at step 607 or 707.

At step 608 or 708, the closed mechanical contacts pair 154 or 155 is opened (in sequence 600, the closed mechanical contacts pair is the MEC+ pair 154, and in the sequence 700, the closed mechanical contacts pair is the MEC− pair 155). At step 609 or 709, the controller 106 verifies that current has ceased to flow through the hybrid circuit interrupter 101, and if there is zero current flow, then the interruption is deemed complete.

As previously noted in the discussion of the PE modules 17, 18 shown in FIG. 2, ON resistance is a characteristic inherent to typical semiconductor devices. By providing a second pair of mechanical contacts in the mechanical branch 151, the disclosed improved hybrid switch mechanism 150 provides a pathway for current flow during an interruption operation that eliminates the need for the non-switching PE module 157 or 156 to be turned on, thus preventing the ON resistance of the non-switching PE module 157 or 156 being introduced to the circuit. That is, during the positive voltage interruption sequence 600, after current is commutated to the PE+ module 156, facilitating the current to flow from the PE+ module 156 toward the MEC+contacts 154 via the node 159 rather than from the PE+ module 156 toward the non-switching PE− module 157 prevents resistive losses that would otherwise occur if the ON resistance of the non-switching PE− module 157 were introduced to the circuit. During the negative voltage interruption sequence 700, after current is commutated to the PE− module 157, facilitating the current to flow from the PE− module 157 the MEC− contacts 155 via the node 159 rather than from the PE− module 157 toward the non-switching PE+ module 156 prevents resistive losses that would otherwise occur if the ON resistance of the non-switching PE+ module 156 were introduced to the circuit. It will be appreciated that preventing the flow of current through the non-switching PE module 157 or 156 in the improved hybrid switching mechanism 150 effectively decreases the resistive heat losses that occur by one half, relative to the hybrid switching mechanism 10 (since in the hybrid switching mechanism 10, the ON resistance from both the PE+ module 17 and the PE− module 18 are introduced to the circuit during every interruption operation).

In addition, the geometry of a current path affects case of commutation, and by only introducing one of the PE modules 156 or 157 (instead of both) to the circuit during an interruption event, commutation performance of the hybrid switch assembly 150 is improved relative to the prior art hybrid switching mechanism 10 due to the lesser change in impedance that the commutating current has to overcome. The prior art hybrid switching mechanism 10 has an elongated current path/geometry during an interruption event compared to the improved hybrid switch assembly 150 due to the prior art hybrid switching mechanism 10 requiring both PE modules 17, 18 to be used during every interruption event. In the prior art hybrid switching mechanism 10, the longer current path results in added loop inductance, i.e. greater impedance/greater opposition to changes in current. Thus, only requiring one of the PE modules 156 or 157 for an interruption operation in the hybrid switch assembly 150 improves commutation performance by reducing the change in impedance the commutating current has to overcome.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A hybrid switch assembly for use in a circuit interrupter, the hybrid switch assembly comprising:
a line side node configured to be connected to a power source;
a load side node configured to be connected to a load;
a mechanical branch connected between the line side node and the load side node, the mechanical branch comprising:
a first pair of separable contacts, the first pair of separable contacts being designated as MEC+ separable contacts; and
a second pair of separable contacts positioned in series with the first pair of separable contacts, the second pair of separable contacts being designated as MEC− separable contacts;
a power electronics, PE, branch connected between the line side node and the load side node in parallel with the mechanical branch, the PE branch comprising:
a first PE module configured to conduct current in a first direction, the first PE module being designated as a PE+ module; and
a second PE module configured to conduct current in a second direction oriented opposite the first direction, the second PE module being designated as a PE− module; and
a control power circuit configured to selectively actuate each of the PE+ module and the PE− module between a conducting state and a nonconducting state,
wherein the MEC+ separable contacts form a first hybrid interrupting arrangement with the PE+ module and are connected in parallel with the PE− module, and
wherein the MEC− separable contacts form a second hybrid interrupting arrangement with the PE− module and are connected in parallel with the PE+ module.

2. The hybrid switch assembly of claim 1, further comprising:
a common node electrically connected to the MEC+ separable contacts, the MEC− separable contacts, the PE+ module, and the PE− module,
wherein the common node is positioned between the MEC+ separable contacts and the MEC− separable contacts, and
wherein the common node is positioned between the PE+ module and the PE− module.

3. The hybrid switch assembly of claim 2,
wherein the PE+ module and the MEC− separable contacts are connected in parallel between the line side node and the common node, and
wherein the PE− module and the MEC+ separable contacts are connected in parallel between the common node and the load side node.

4. The hybrid switch assembly of claim 1,
wherein the MEC+ separable contacts and the MEC− separable contacts are configured to stay closed and the PE branch is configured to remain powered off when current through the hybrid switch assembly is within a normal operating range of the circuit interrupter,
wherein the hybrid switch assembly is configured such that, when current is flowing in the first direction:
the MEC− separable contacts are configured to open,
the control power circuit is configured to power on the PE+ module and to keep the PE− module powered off after the MEC− separable contacts have opened, in order to commutate current to the PE+ module,
the control power circuit is configured to power off the PE+ module after commutation of current to the PE+ module is complete, and
the MEC+ separable contacts are configured to open after the PE+ module is powered off.

5. The hybrid switch assembly of claim 4,
wherein the hybrid switch assembly is configured such that, when current is flowing in the second direction:
the MEC+ separable contacts are configured to open,
the control power circuit is configured to power on the PE− module and to keep the PE+ module powered off after the MEC+ separable contacts have opened, in order to commutate current to the PE− module,
the control power circuit is configured to power off the PE− module after commutation of current to the PE− module is complete, and
the MEC− separable contacts are configured to open after the PE− module is powered off.

6. The hybrid switch assembly of claim 3,
wherein the PE+ module comprises a first n-channel MOSFET whose drain terminal is connected to the line side node and whose source terminal is connected to the common node, and
wherein the PE− module comprises a second n-channel MOSFET whose drain terminal is connected to the load side node and whose source terminal is connected to the common node.

7. The hybrid switch assembly of claim 6,
wherein a gate terminal of the first n-channel MOSFET and a gate terminal of the second n-channel MOSFET are configured to receive input from the control power circuit.

8. A hybrid circuit interrupter structured to be connected between a power source and a load, the hybrid circuit interrupter comprising:
a current sensor structured to sense current flowing through the hybrid circuit interrupter;
a voltage sensor structured to sense voltage in the hybrid circuit interrupter;
a controller configured to receive data from the current sensor and the voltage sensor;
an operating mechanism configured to be actuated by the controller; and
a hybrid switch assembly, the hybrid switch assembly comprising:
a line side node configured to be connected to the power source;
a load side node configured to be connected to the load;
a mechanical branch connected between the line side node and the load side node, the mechanical branch comprising:
a first pair of separable contacts, the first pair of separable contacts being designated as MEC+ separable contacts; and
a second pair of separable contacts positioned in series with the first pair of separable contacts, the second pair of separable contacts being designated as MEC− separable contacts;
a power electronics, PE, branch connected between the line side node and the load side node in parallel with the mechanical branch, the PE branch comprising:
a first PE module configured to conduct current in a first direction, the first PE module being designated as a PE+ module; and
a second PE module configured to conduct current in a second direction oriented opposite the first direction, the second PE module being designated as a PE− module; and
a control power circuit in communication with the controller and configured to selectively actuate each of the PE+ module and the PE− module between a conducting state and a nonconducting state,
wherein the MEC+ separable contacts form a first hybrid interrupting arrangement with the PE+ module and are connected in parallel with the PE− module, and
wherein the MEC− separable contacts form a second hybrid interrupting arrangement with the PE− module and are connected in parallel with the PE+ module.

9. The hybrid circuit interrupter of claim 8,
wherein the hybrid switch assembly further comprises a common node electrically connected to the MEC+ separable contacts, the MEC− separable contacts, the PE+ module, and the PE− module,
wherein the common node is positioned between the MEC+ separable contacts and the MEC− separable contacts, and
wherein the common node is positioned between the PE+ module and the PE− module.

10. The hybrid circuit interrupter of claim 9,
wherein the PE+ module and the MEC− separable contacts are connected in parallel between the line side node and the common node, and
wherein the PE− module and the MEC+ separable contacts are connected in parallel between the common node and the load side node.

11. The hybrid circuit interrupter of claim 8,
wherein the MEC+ separable contacts and the MEC− separable contacts are configured to stay closed and the PE branch is configured to remain powered off when current through the hybrid switch assembly is within a normal operating range of the circuit interrupter,
wherein the hybrid circuit interrupter is configured such that, when current is flowing in the first direction:
the controller is configured to actuate the operating mechanism to open the MEC− separable contacts,
the controller is configured to instruct the control power circuit to power on the PE+ module and to keep the PE− module powered off after the MEC− separable contacts have opened, in order to commutate current to the PE+ module,
the controller is configured to instruct the control power circuit to power off the PE+ module after commutation of current to the PE+ module is complete, and the controller is configured to actuate the operating mechanism to open the MEC+ separable contacts after the PE+ module is powered off.

12. The hybrid circuit interrupter of claim 11,
wherein the hybrid circuit interrupter is configured such that, when current is flowing in the second direction:
the controller is configured to actuate the operating mechanism to open the MEC+ separable contacts,
the controller is configured to instruct the control power circuit to power on the PE− module and to keep the PE+ module powered off after the MEC+ separable contacts have opened, in order to commutate current to the PE− module,
the controller is configured to instruct the control power circuit to power off the PE− module after commutation of current to the PE− module is complete, and
the controller is configured to actuate the operating mechanism to open the MEC− separable contacts after the PE− module is powered off.

13. The hybrid circuit interrupter of claim 10,
wherein the PE+ module comprises a first n-channel MOSFET whose drain terminal is connected to the line side node and whose source terminal is connected to the common node, and
wherein the PE− module comprises a second n-channel MOSFET whose drain terminal is connected to the load side node and whose source terminal is connected to the common node.

14. The hybrid circuit interrupter of claim 13,
wherein a gate terminal of the first n-channel MOSFET and a gate terminal of the second n-channel MOSFET are configured to receive input from the control power circuit.

15. A method of interrupting current flowing between a power source and a load, the method comprising:
providing a hybrid circuit interrupter electrically connected between the power source and the load, the hybrid circuit interrupter including a hybrid switch assembly and a controller, wherein the hybrid switch assembly includes a mechanical branch and a power electronics, PE, branch connected in parallel with the mechanical branch, the mechanical branch including a first pair of separable contacts designated as MEC+ separable contacts and a second pair of separable contacts designated as MEC− separable contacts, the MEC+ separable contacts and the MEC− separable contacts being positioned in series;
maintaining the MEC+ separable contacts and the MEC− separable contacts in a closed state and keeping the PE branch powered off when the current is within a normal operating range of the circuit interrupter; and
when the current reaches a fault level threshold:
determining with the controller whether the current is in a positive voltage half-cycle or in a negative voltage half-cycle; and
initiating with the controller a positive voltage interruption sequence when the current is in the positive voltage half-cycle and initiating a negative voltage interruption sequence when the current is in the negative voltage half-cycle,
wherein the PE branch includes a first PE module designated as a PE+ module that is configured to conduct current in a first direction and a second PE module designated as a PE− module configured to conduct current in a second direction,
wherein the MEC+ separable contacts form a first hybrid interrupting arrangement with the PE+ module and are connected in parallel with the PE− module, and
wherein the MEC− separable contacts form a second hybrid interrupting arrangement with the PE− module and are connected in parallel with the PE+ module.

16. The method of claim 15,
wherein the MEC+ separable contacts and the MEC− separable contacts share a common node positioned between the MEC+ separable contacts and the MEC− separable contacts, and
wherein the common node connects the mechanical branch to the PE branch between the PE+ module and the PE− module.

17. The method of claim 16,
wherein the hybrid switch assembly includes a line side node configured to be connected to the power source and a load side node configured to be connected to the load, and
wherein the PE+ module and the MEC− separable contacts are connected in parallel between the line side node and the common node, and
wherein the PE− module and the MEC+ separable contacts are connected in parallel between the common node and the load side node.

18. The method of claim 17,
wherein the PE+ module comprises a first n-channel MOSFET whose drain terminal is connected to the line side node and whose source terminal is connected to the common node, and
wherein the PE− module comprises a second n-channel MOSFET whose drain terminal is connected to the load side node and whose source terminal is connected to the common node.

19. The method of claim 15, wherein the positive voltage interruption sequence comprises:
opening the MEC− separable contacts with an operating mechanism of the hybrid circuit interrupter;
checking arc voltage that forms across a voltage gap of the MEC− separable contacts with the controller;
powering on the PE+ module using the controller once the arc voltage across the voltage gap of the MEC− separable contacts is above a commutation threshold;
checking the current with the controller to determine whether the arc voltage across the MEC− separable contacts is extinguished;
powering off the PE+ module using the controller once the arc voltage across the MEC− separable contacts is extinguished;
opening the MEC+ separable contacts with the operating mechanism; and
verifying with the controller that the current has ceased to flow.

20. The method of claim 19, wherein the negative voltage interruption sequence comprises:
opening the MEC+ separable contacts with the operating mechanism;
checking arc voltage that forms across a voltage gap of the MEC+ separable contacts with the controller;
powering on the PE− module using the controller once the arc voltage across the voltage gap of the MEC+ separable contacts is above a commutation threshold;
checking the current with the controller to determine whether the arc voltage across the MEC+ separable contacts is extinguished;
powering off the PE− module using the controller once the arc voltage across the MEC+ separable contacts is extinguished;
opening the MEC− separable contacts with the operating mechanism; and
verifying with the controller that the current has ceased to flow.
